(19) United States
(12) Patent Application Publication
(10) Pub. No.: US 2025/0356044 A1
(43) Pub. Date: Nov. 20, 2025

(54) ROW LEVEL SECURITY ON DATABASE OBJECTS

(71) Applicant: SAP SE, Walldorf (DE)

(72) Inventors: Yinghua Ouyang, Xi'an (CN); Taehyung Lee, Seoul (KR); Ki Hong Kim, Seoul (KR); Yanchen Cao, Xi'an (CN); Boyang Zhang, Xi'an (CN); Xun Zhang, Xi'an (CN); Zhen Tian, Xi'an (CN)

(21) Appl. No.: 18/664,660

(22) Filed: May 15, 2024

(51) Int. Cl. G06F 21/62; G06F 16/2453

(52) U.S. Cl. CPC G06F 21/6227; G06F 16/24542

(57) ABSTRACT

When a query targeting a database object is detected, a database management system determines whether a row level security policy is defined for the database object. If a row level security policy is defined for the database object, the database management system dynamically generates a filter predicate string based on the row level security policy. Then, the filter predicate string is converted into a query optimizer predicate. Next, the query optimizer predicate is injected into a query plan corresponding to the query. Then, a first query result set is generated during execution of the query plan and the query optimizer predicate is applied to the first query result set. In an example, applying the query optimizer predicate to the first query result set results in the creation of a second query result set which is a truncated version of the first query result set.

### TECHNICAL FIELD

The present disclosure generally relates to implementing security for database objects.

### BACKGROUND

Database management systems have become an integral part of many computer systems. For example, some systems handle hundreds if not thousands of transactions per second. On the other hand, some systems perform very complex multidimensional analysis on data. In both cases, the underlying database may need to handle responses to queries very quickly in order to satisfy systems requirements with respect to transaction time. Given the complexity of these queries and/or their volume, the underlying databases face challenges when attempting to optimize performance.

A database query is a mechanism for retrieving data from one or more database tables. Queries may be generated in accordance with a corresponding query language. For example, structured query language (SQL) is a declarative querying language that is used to retrieve data from a relational database. In some cases, a view may be created by retrieving database data in response to a query. A view may contain data from a single database table or the view may combine data from multiple database tables. As used herein, the term “view” may be defined as a derived table. Alternatively, the term “view” may be defined as a virtual database table. Additionally, as used herein, the term “database object” may be defined as a table, view, or other type of data structure stored in a database and/or data structure generated based on data stored in the database.

### SUMMARY

In some implementations, when a query targeting a database object is detected, a database management system determines whether a row level security policy is defined for the database object. If a row level security policy is defined for the database object, the database management system dynamically generates a filter predicate string based on the row level security policy. Then, the filter predicate string is converted into a query optimizer predicate. Next, the query optimizer predicate is injected into a query plan corresponding to the query. Then, a first query result set is generated during execution of the query plan and the query optimizer predicate is applied to the first query result set. In an example, applying the query optimizer predicate to the first query result set results in the creation of a second query result set which is a truncated version of the first query result set.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates a diagram of an example of a computing system, in accordance with some example implementations of the current subject matter;

FIG. 2 illustrates an example of code for creating a view protected by row level security, in accordance with some example implementations of the current subject matter;

FIG. 3 illustrates an example of SQL code for managing a binding between a database object and a condition provider procedure, in accordance with some example implementations of the current subject matter;

FIG. 4 illustrates an example of a statement for retrieving a dynamically generated filter predicate string to be applied to a query result set, in accordance with some example implementations of the current subject matter;

FIG. 5 illustrates diagrams of query optimizer (QO) trees, in accordance with some example implementations of the current subject matter;

FIG. 6 illustrates an example of a process for implementing row level security on a database object, in accordance with some example implementations of the current subject matter;

FIG. 7 illustrates an example of a process for invoking row level security during query execution, in accordance with some example implementations of the current subject matter;

FIG. 8A depicts an example of a system, in accordance with some example implementations of the current subject matter; and

FIG. 8B depicts another example of a system, in accordance with some example implementations of the current subject matter.

### DETAILED DESCRIPTION

Row level security enables users to use execution context to control access to rows in a database object (e.g., a table, a view). In an example, sales data for all regions are contained within one analytic view. However, regional sales managers should only see the data for their region. In this case, a row level security mechanism could be modeled so that all users can query the view, but only the data that each user is authorized to see is returned. However, without such a row level access control mechanism, users would have to write complex functions to implement their specific row level access control. This not only increases the complexity of usage, but also reduces query performance.

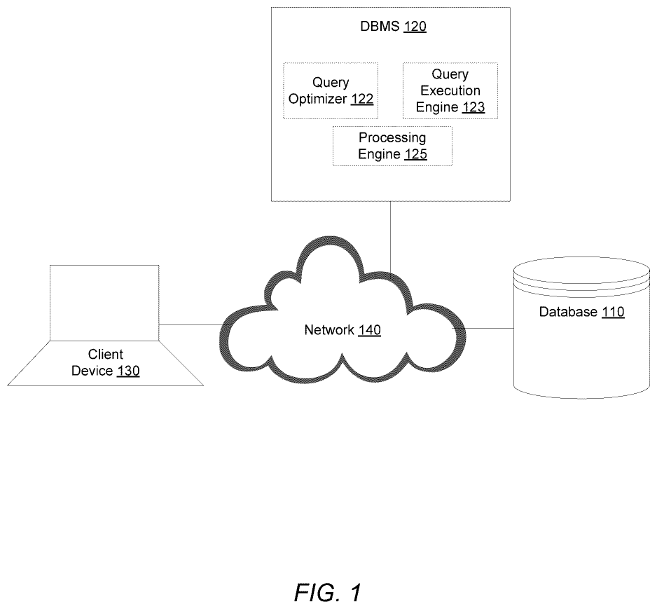

FIG. 1 depicts an example of a computing system 100, in accordance with some example embodiments. Referring to FIG. 1, the computing system 100 may include a database 110, a database management system (DBMS) 120, and a client device 130. In an example, database management system 120 includes query optimizer 122, query execution engine 123, and processing engine 125. In other examples, database management system 120 may include other types of components. It is noted that while only a single database 110 and a single client device 130 are shown in FIG. 1, this is merely to avoid cluttering the figure. It should be appreciated that database 110 is representative of any number of databases 110 and client device 130 is representative of any number of client devices that may included as part of computing system 100.

From an application or client perspective, it can be extremely cumbersome to access databases such as database 110. For example, an application may need to query different types of databases using complex queries. As a consequence, the application layer would need to be configured to handle the various types of databases and the various query types. Additionally or alternatively, each database 110 may need to process queries from the application into a format and structure that can be handled by the given database. Pushing complex operations and support for a variety of different database types to the application layer may contravene the need to have relatively lighter weight and/or readily deployable applications. On the other hand, pushing complex operations to the database layer where data is stored may draw processing and/or memory resources at the database 110 and may thus reduce the performance and response times for queries on that database layer.

In some example implementations, there may be provided a query execution engine 123 and/or processing engine 125 that may decouple the higher-level, application layer from the database layer (e.g., the persistence or storage layer where data including database tables may be stored and/or queried using instructions, such as commands and/or the like). The query execution engine 123 and/or processing engine 125 may be implemented separately from the database layer and/or the application layer. Further, the query execution engine 123 and/or processing engine 125 may be configured to receive a query, generate a query plan (including for example query algebra), optimize the query plan, and/or generate executable code, which can be executed at runtime. The executable code may include pre-compiled code (which can be selected for certain operations in the query plan) and/or code that is generated just-in-time specifically for execution of the query plan.

The database 110, the database management system 120, and the client device 130 may be communicatively coupled via a network 140. In some example embodiments, the database 110 may be a relational database. However, it should be appreciated that the database 110 may be any type of database including, for example, an in-memory database, a hierarchical database, an object database, an object-relational database, and/or the like. For example, instead of and/or in addition to being a relational database, the database 110 may be a graph database, a column store, a key-value store, a document store, and/or the like.

The database management system 120 may be configured to respond to requests from one or more client devices including, for example, the client device 130. For example, as shown in FIG. 1, the client device 130 may communicate with the database management system 120 via the network 140, which may be any wired and/or wireless network including, for example, a public land mobile network (PLMN), a wide area network (WAN), a local area network (LAN), a virtual local area network (VLAN), the Internet, and/or the like. The client device 130 may be a processor-based device including, for example, a smartphone, a tablet computer, a wearable apparatus, a virtual assistant, an Internet-of-Things (IoT) appliance, and/or the like.

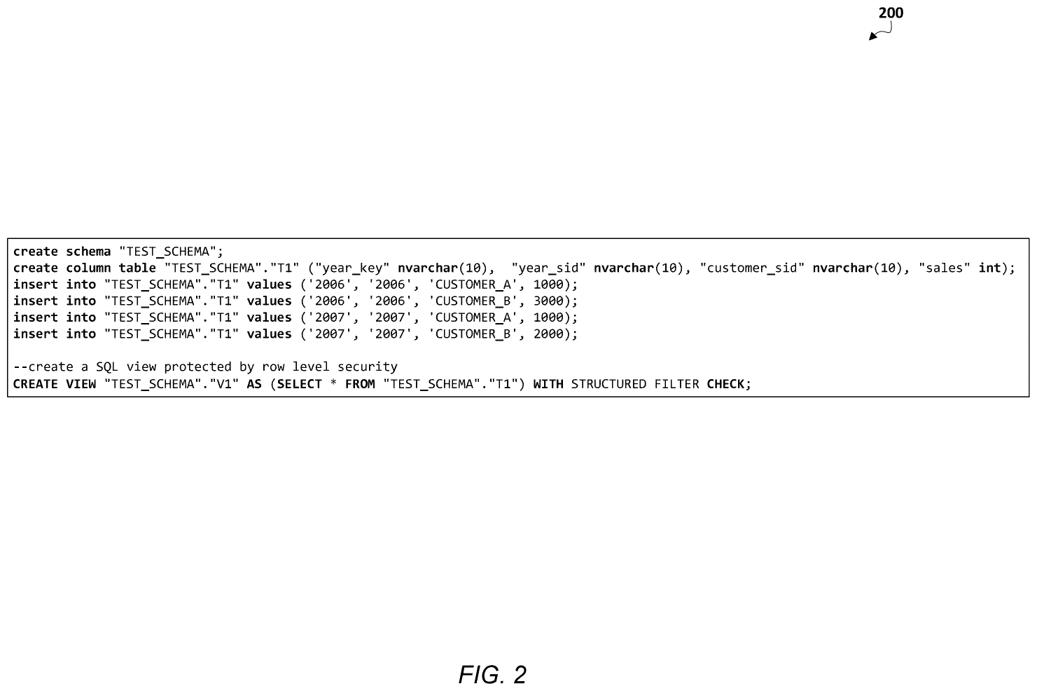

Turning now to FIG. 2, an example of code 200 for creating a view protected by row level security is shown, in accordance with one or more embodiments of the current subject matter. In FIG. 2, an example of SQL code 200 for creating a table named “TEST_SCHEMA” is shown. The columns of the table are created and then values are inserted into these columns. Then, at the bottom of the example of SQL code 200, a SQL view protected by row level security is created. In this example, the statement “CREATE VIEW “TEST_SCHEMA”.“V1” AS (SELECT*FROM “TEST_SCHEMA”.“T1”) WITH STRUCTURED FILTER CHECK” creates the SQL view protected by row level security. As a result of this statement, a row level security protection flag will be saved in the table metadata. It should be understood that the statements shown in SQL code 200 are merely illustrative of one example for protecting a database object with a row level security policy. In other examples, other collections of statements may be employed for protecting a database object with a row level security policy.

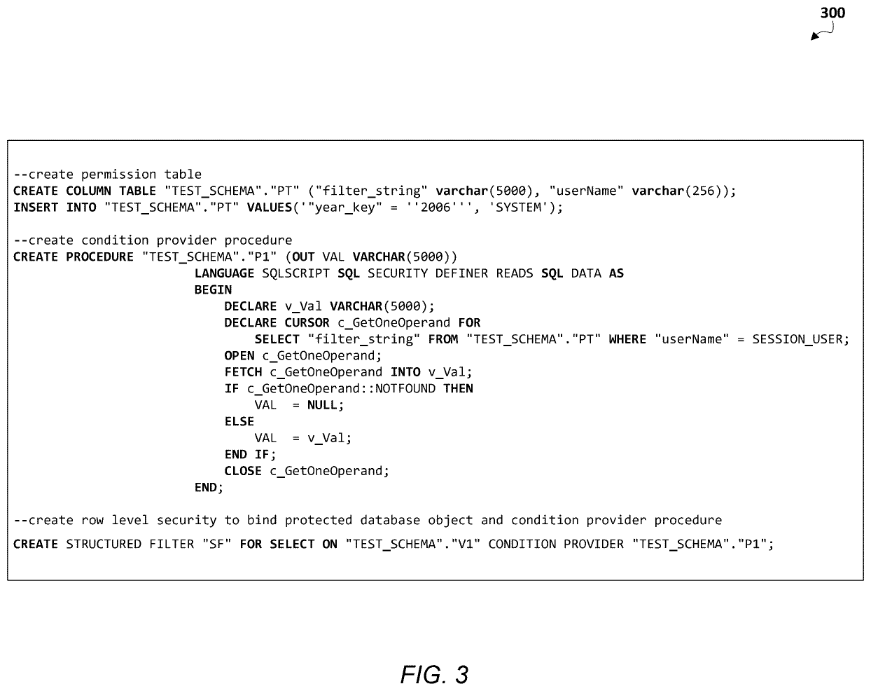

Turning now to FIG. 3, an example of SQL code 300 for managing a binding between a database object and a condition provider procedure is shown, in accordance with one or more embodiments of the current subject matter. In an example, a permission table may be created for the table “TEST_SCHEMA”, as shown in the upper portion of SQL code 300. Then, a condition provider procedure may be created as shown in the middle portion of SQL code 300. In an example, a condition provider procedure is a SQL procedure that returns an authorization filter for a given application user. Finally, a binding between the protected database object and the condition provider procedure is created with the final expression at the bottom of SQL code 300. The result is the row level security policy binding the table “TEST_SCHEMA” and the condition provider procedure.

It should be understood that the statements shown in SQL code 300 are merely illustrative of one example for managing a binding between a database object and a condition provider procedure. In other examples, other collections of statements may be employed for managing a binding between a database object and a condition provider procedure.

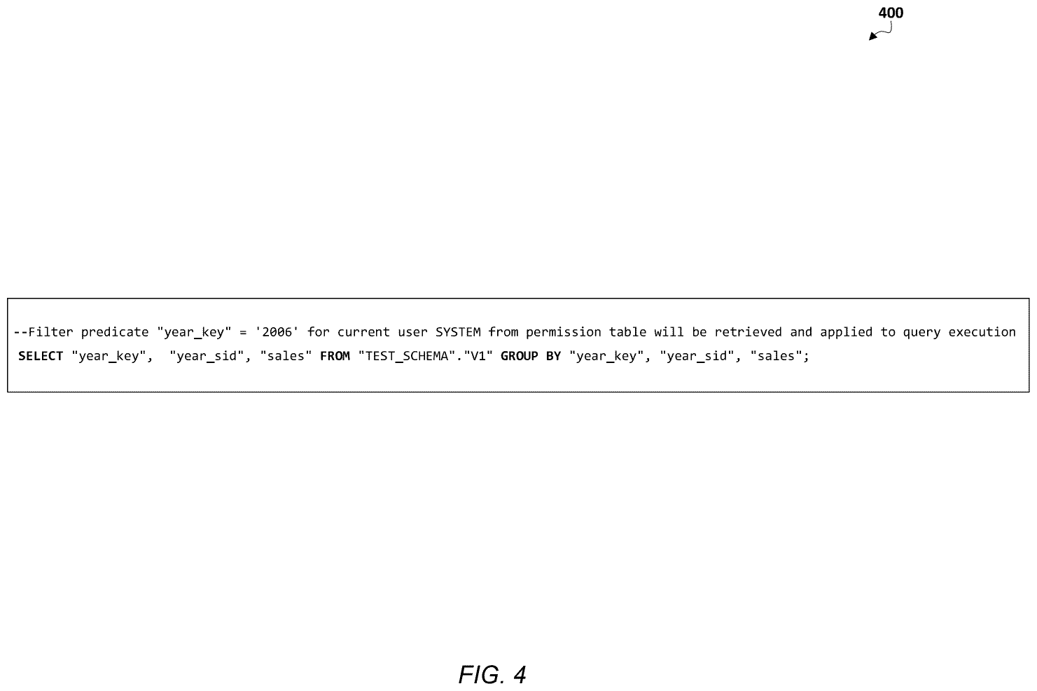

Referring now to FIG. 4, an example of a statement 400 for retrieving a dynamically generated filter predicate string to be applied to a query result set is shown, in accordance with one or more embodiments of the current subject matter. In an example, when a user queries a database object, if a row level security policy is defined for the database object, then a filter predicate string is dynamically generated based on the row level security policy. In an example, the filter predicate string is dynamically generated from a permission table by invoking a condition provider procedure. Next, the dynamically generated filter predicate string is converted to a query optimizer (QO) predicate. Then, the QO predicate is injected into a query plan and applied to a query result set. The statement 400 is an example of a statement for retrieving a dynamically generated filter predicate string to be applied to a query result set.

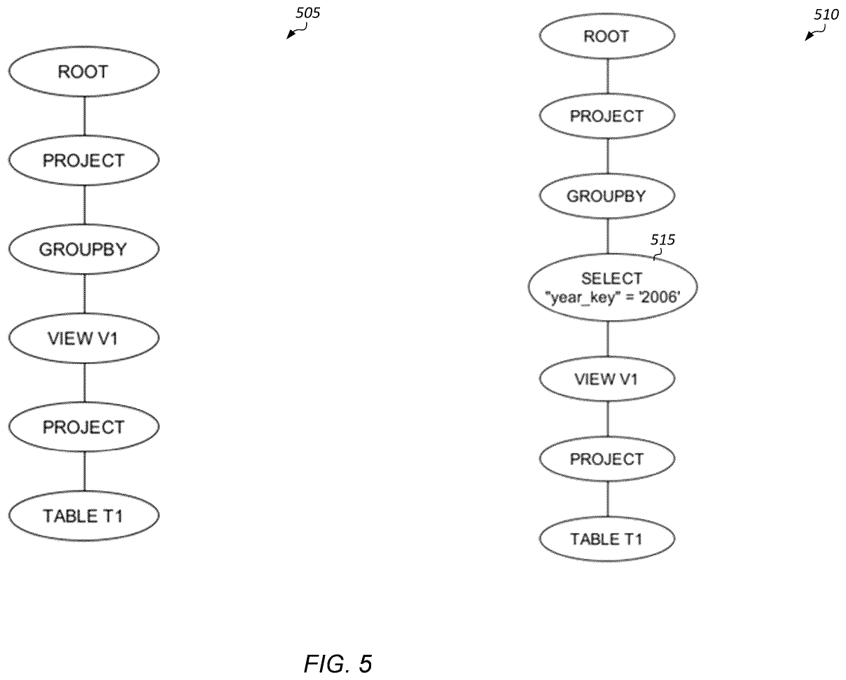

Turning now to FIG. 5, diagrams of query optimizer (QO) trees 505 and 510 are shown, in accordance with one or more embodiments of the current subject matter. As shown on the left-side of FIG. 5, QO tree 505 corresponds to view “V1” from SQL code 200 (of FIG. 2) before the filter predicate string is dynamically generated. The right-side of FIG. 5 shows the QO tree 510 after the filter predicate string is dynamically generated and a corresponding QO predicate 515 is injected into the tree.

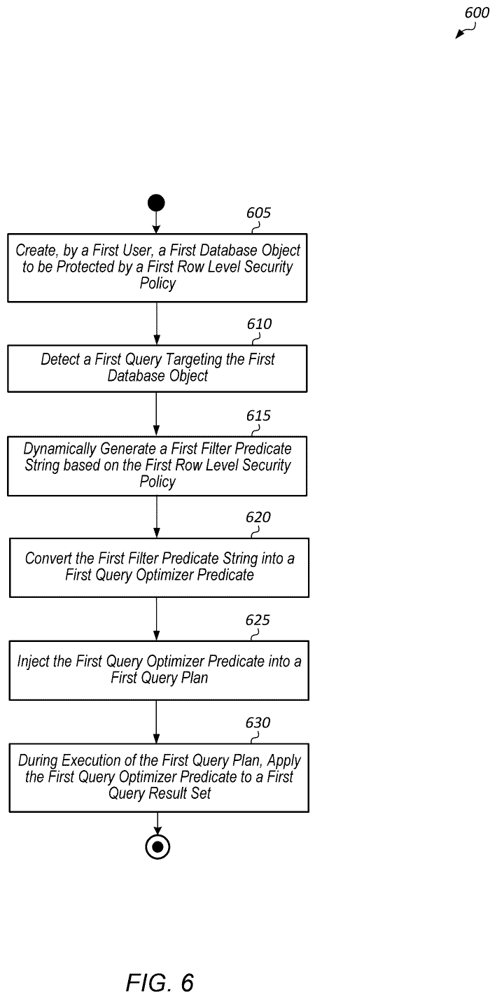

Turning now to FIG. 6, a process is depicted for implementing row level security on a database object, in accordance with one or more embodiments of the current subject matter. A first database object is created by a first user to be protected by a first row level security policy (block 605). In an example, the first row level security policy is defined for the first database object using a data definition language (DDL) statement.

Then, at a later point in time, a database management system (e.g., DBMS 120 of FIG. 1) detects a first query targeting the first database object (block 610). It may be assumed for the purposes of this discussion that the first query is generated by a second user different from the first user who created the first database object. In response to detecting the first query, the database management system dynamically generates a first filter predicate string based on the first row level security policy (block 615). The first filter predicate string is dynamically generated in the sense that the filter predicate string is generated in response to detecting the first query rather than being generated ahead of time. In other words, the first filter predicate string is dynamically generated at query time. Next, the database management system converts the first filter predicate string into a first query optimizer predicate (block 620). As used herein, the term “query optimizer predicate” may be defined as a predicate which is inserted into a query optimizer tree and applied to one or more nodes of the query optimizer tree. As used herein, the term “predicate” may be defined as a statement or function based on one or more input parameters that returns a Boolean (e.g., binary variable) as an output. After block 620, the database management system injects the first query optimizer predicate into a first query plan (block 625).

Next, during execution of the first query plan, the database management system applies the first query optimizer predicate to a first query result set (block 630). After block 630, method 600 may end. In an example, applying the first query optimizer predicate to the first query result set creates a second query result set which is a truncated version of the first query result set. It is noted that method 600 may be performed any number of times to implement row level security on any number of database objects (e.g., a second database object, a third database object). Each database object may have its own unique row level security policy which is distinct from the row level security policies of other database objects.

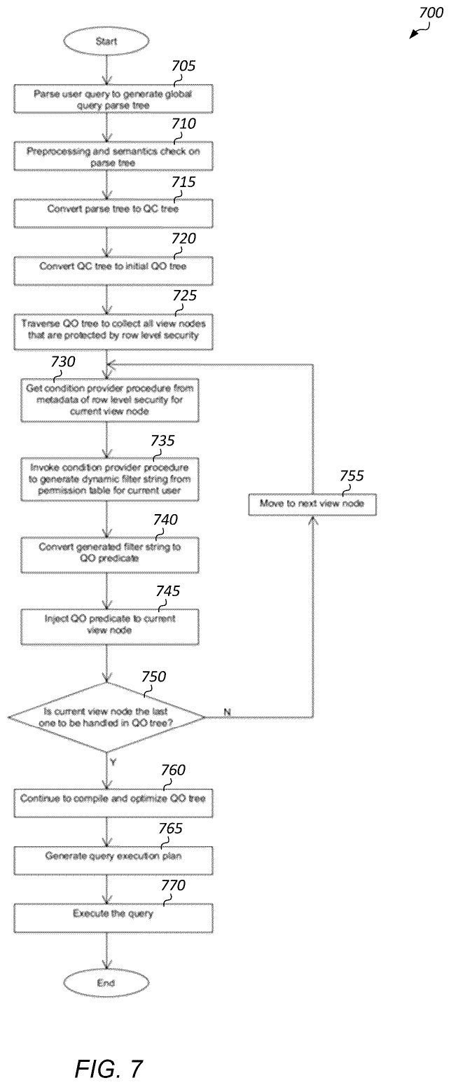

Turning now to FIG. 7, a process is depicted for invoking row level security during query execution, in accordance with one or more embodiments of the current subject matter. A user query is parsed by a database management system (e.g., DBMS 120 of FIG. 1) to generate a global query parse tree (block 705). Next, preprocessing and a semantics check are performed on the global query parse tree (block 710). Then, the global query parse tree is converted into an initial query compile (QC) tree (block 715). As used herein, the term “query compile tree” is defined as a transition tree between a global query parse tree and an optimizer tree. Next, the query compile tree is converted into an initial query optimizer (QO) tree (block 720).

Then, the query optimizer tree is traversed to collect all view nodes that are protected by row level security (block 725). For each collected view node, the defined condition provider procedure is retrieved from the metadata of row level security for the current view node (block 730). Also, a condition provider procedure is invoked to generate a dynamic filter predicate string from a permission table for the current user (block 735). Next, the generated filter predicate string is converted into a query optimizer predicate (block 740). Then, the query optimizer predicate is injected into the current view node in the QO tree (block 745).

If the current view node is the last view node to be handled in the QO tree (conditional block 750, “yes” leg), then the database management system continues to compile and optimize the QO tree (block 760). Otherwise, if the current view node is not the last view node to be handled in the QO tree (conditional block 750, “no” leg), then the database management system moves to the next view node (block 755) and then method 700 returns to block 730. After block 760, the database management system generates a query execution plan based on the QO tree (block 765) and then executes the query (block 770). After block 770, method 700 may end.

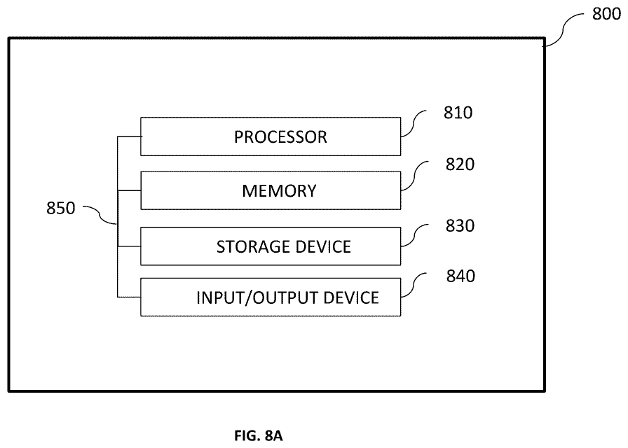

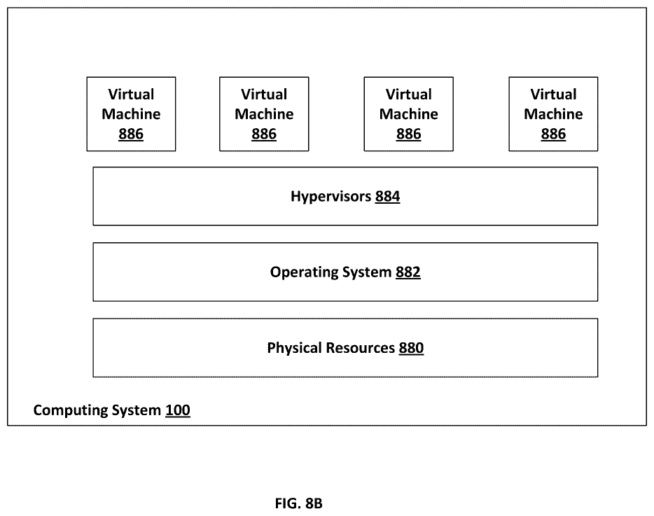

In some implementations, the current subject matter may be configured to be implemented in a system 800, as shown in FIG. 8A. The system 800 may include a processor 810, a memory 820, a storage device 830, and an input/output device 840. Each of the components 810, 820, 830 and 840 may be interconnected using a system bus 850. The processor 810 may be configured to process instructions for execution within the system 800. In some implementations, the processor 810 may be a single-threaded processor. In alternate implementations, the processor 810 may be a multi-threaded processor. The processor 810 may be further configured to process instructions stored in the memory 820 or on the storage device 830, including receiving or sending information through the input/output device 840. The memory 820 may store information within the system 800. In some implementations, the memory 820 may be a computer-readable medium. In alternate implementations, the memory 820 may be a volatile memory unit. In yet some implementations, the memory 820 may be a non-volatile memory unit. The storage device 830 may be capable of providing mass storage for the system 800. In some implementations, the storage device 830 may be a computer-readable medium. In alternate implementations, the storage device 830 may be a floppy disk device, a hard disk device, an optical disk device, a tape device, non-volatile solid state memory, or any other type of storage device. The input/output device 840 may be configured to provide input/output operations for the system 800. In some implementations, the input/output device 840 may include a keyboard and/or pointing device. In alternate implementations, the input/output device 840 may include a display unit for displaying graphical user interfaces.

FIG. 8B depicts an example implementation of the computing system 100 (of FIG. 1). The computing system 100 may be implemented using various physical resources 880, such as at least one or more hardware servers, at least one storage, at least one memory, at least one network interface, and the like. The computing system 100 may also be implemented using infrastructure, as noted above, which may include at least one operating system 882 for the physical resources 880 and at least one hypervisor 884 (which may create and run at least one virtual machine 886). For example, each multitenant application may be run on a corresponding virtual machine 886.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

Although ordinal numbers such as first, second and the like can, in some situations, relate to an order; as used in a document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include program instructions (i.e., machine instructions) for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives program instructions as a machine-readable signal. The term “machine-readable signal” refers to any signal used to provide machine instructions and/or data to a programmable processor. The machine-readable medium can store such program instructions non-transitorily, such as for example as would a non-transient solid state memory or a magnetic hard drive or any equivalent storage medium. The machine-readable medium can alternatively or additionally store such machine instructions in a transient manner, such as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Example 1: A computer-implemented method comprising: detecting a first query targeting a first database object; responsive to determining that a first row level security policy is defined for the first database object: dynamically generating a first filter predicate string based on the first row level security policy; converting the first filter predicate string into a first query optimizer predicate; injecting the first query optimizer predicate into a first query plan; generating a first query result set during execution of the first query plan; and applying the first query optimizer predicate to the first query result set.

Example 2: The computer-implemented method of Example 1, further comprising dynamically generating the first filter predicate string by invoking a condition provider procedure.

Example 3: The computer-implemented method of any of Examples 1-2, wherein applying the first query optimizer predicate to the first query result set comprises creating a second query result set which is a truncated version of the first query result set.

Example 4: The computer-implemented method of any of Examples 1-3, wherein the first row level security policy is defined by a first user.

Example 5: The computer-implemented method of any of Examples 1-4, wherein the second query result set is specific to a second user that caused the first query to be generated.

Example 6: The computer-implemented method of any of Examples 1-5, further comprising detecting creation of a second database object to be protected by a second row level security policy different from the first row level security policy.

Example 7: The computer-implemented method of any of Examples 1-6, wherein the second row level security policy binds the second database object and a condition provider procedure.

Example 8: The computer-implemented method of any of Examples 1-7, further comprising dynamically generating a second filter predicate string by invoking the condition provider procedure in response to detecting a second query targeting the second database object.

Example 9: The computer-implemented method of any of Examples 1-8, wherein a first row level security protection flag is saved in object metadata associated with the first database object.

Example 10: The computer-implemented method of any of Examples 1-9, further comprising: detecting a second query; generating a query optimizer tree based on the second query; traversing the query optimizer tree to collect any view nodes that are protected by row level security policies; for each collected view node: retrieving metadata of a corresponding row level security policy for the collected view node; invoking a condition provider procedure to dynamically generate a filter predicate string from a permission table for a current user; converting the filter predicate string to a query optimizer predicate; and injecting the query optimizer predicate into the collected view node in the query optimizer tree.

Example 11: A system comprising: at least one processor; at least one memory storing instructions that, when executed by the at least one processor, cause operations comprising: dynamically generating a first filter predicate string based on the first row level security policy; converting the first filter predicate string into a first query optimizer predicate; injecting the first query optimizer predicate into a first query plan; generating a first query result set during execution of the first query plan; and applying the first query optimizer predicate to the first query result set.

Example 12: The system of Example 11, wherein the operations further comprise dynamically generating the first filter predicate string by invoking a condition provider procedure.

Example 13: The system of any of Examples 11-12, wherein applying the first query optimizer predicate to the first query result set comprises creating a second query result set which is a truncated version of the first query result set.

Example 14: The system of any of Examples 11-13, wherein the first row level security policy is defined by a first user.

Example 15: The system of any of Examples 11-14, wherein the second query result set is specific to a second user that caused the first query to be generated.

Example 16: The system of any of Examples 11-15, wherein the operations further comprise detecting creation of a second database object to be protected by a second row level security policy different from the first row level security policy.

Example 17: The system of any of Examples 11-16, wherein the second row level security policy binds the second database object and a condition provider procedure.

Example 18: The system of any of Examples 11-17, wherein the operations further comprise dynamically generating a second filter predicate string by invoking the condition provider procedure in response to detecting a second query targeting the second database object.

Example 19: The system of any of Examples 11-18, wherein the operations further comprising: detecting a second query; generating a query optimizer tree based on the second query; traversing the query optimizer tree to collect any view nodes that are protected by row level security policies; for each collected view node: retrieving metadata of a corresponding row level security policy for the collected view node; invoking a condition provider procedure to dynamically generate a filter predicate string from a permission table for a current user; converting the filter predicate string to a query optimizer predicate; and injecting the query optimizer predicate into the collected view node in the query optimizer tree.

Example 20: A non-transitory computer readable medium storing instructions, which when executed by at least one data processor, result in operations comprising: detecting a first query targeting a first database object; responsive to determining that a first row level security policy is defined for the first database object: dynamically generating a first filter predicate string based on the first row level security policy; converting the first filter predicate string into a first query optimizer predicate; injecting the first query optimizer predicate into a first query plan; generating a first query result set during execution of the first query plan; and applying the first query optimizer predicate to the first query result set.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed:

1. A computer-implemented method comprising:
detecting a first query targeting a first database object;
responsive to determining that a first row level security policy is defined for the first database object:
dynamically generating a first filter predicate string based on the first row level security policy;
converting the first filter predicate string into a first query optimizer predicate;
injecting the first query optimizer predicate into a first query plan;
generating a first query result set during execution of the first query plan; and
applying the first query optimizer predicate to the first query result set.

2. The computer-implemented method of claim 1, further comprising dynamically generating the first filter predicate string by invoking a condition provider procedure.

3. The computer-implemented method of claim 1, wherein applying the first query optimizer predicate to the first query result set comprises creating a second query result set which is a truncated version of the first query result set.

4. The computer-implemented method of claim 3, wherein the first row level security policy is defined by a first user.

5. The computer-implemented method of claim 4, wherein the second query result set is specific to a second user that caused the first query to be generated.

6. The computer-implemented method of claim 1, further comprising detecting creation of a second database object to be protected by a second row level security policy different from the first row level security policy.

7. The computer-implemented method of claim 6, wherein the second row level security policy binds the second database object and a condition provider procedure.

8. The computer-implemented method of claim 7, further comprising dynamically generating a second filter predicate string by invoking the condition provider procedure in response to detecting a second query targeting the second database object.

9. The computer-implemented method of claim 1, wherein a first row level security protection flag is saved in object metadata associated with the first database object.

10. The computer-implemented method of claim 1, further comprising:
detecting a second query;
generating a query optimizer tree based on the second query;
traversing the query optimizer tree to collect any view nodes that are protected by row level security policies;
for each collected view node:
retrieving metadata of a corresponding row level security policy for the collected view node;
invoking a condition provider procedure to dynamically generate a filter predicate string from a permission table for a current user;
converting the filter predicate string to a query optimizer predicate; and
injecting the query optimizer predicate into the collected view node in the query optimizer tree.

11. A system comprising:
at least one processor;
at least one memory storing instructions that, when executed by the at least one processor, cause operations comprising:
detecting a first query targeting a first database object;
responsive to determining that a first row level security policy is defined for the first database object:
dynamically generating a first filter predicate string based on the first row level security policy;
converting the first filter predicate string into a first query optimizer predicate;
injecting the first query optimizer predicate into a first query plan;
generating a first query result set during execution of the first query plan; and
applying the first query optimizer predicate to the first query result set.

12. The system of claim 11, wherein the operations further comprise dynamically generating the first filter predicate string by invoking a condition provider procedure.

13. The system of claim 11, wherein applying the first query optimizer predicate to the first query result set comprises creating a second query result set which is a truncated version of the first query result set.

14. The system of claim 13, wherein the first row level security policy is defined by a first user.

15. The system of claim 14, wherein the second query result set is specific to a second user that caused the first query to be generated.

16. The system of claim 11, wherein the operations further comprise detecting creation of a second database object to be protected by a second row level security policy different from the first row level security policy.

17. The system of claim 16, wherein the second row level security policy binds the second database object and a condition provider procedure.

18. The system of claim 17, wherein the operations further comprise dynamically generating a second filter predicate string by invoking the condition provider procedure in response to detecting a second query targeting the second database object.

19. The system of claim 11, wherein the operations further comprising:
detecting a second query;
generating a query optimizer tree based on the second query;
traversing the query optimizer tree to collect any view nodes that are protected by row level security policies;
for each collected view node:
retrieving metadata of a corresponding row level security policy for the collected view node;
invoking a condition provider procedure to dynamically generate a filter predicate string from a permission table for a current user;
converting the filter predicate string to a query optimizer predicate; and
injecting the query optimizer predicate into the collected view node in the query optimizer tree.

20. A non-transitory computer readable medium storing instructions, which when executed by at least one data processor, result in operations comprising:
detecting a first query targeting a first database object;
responsive to determining that a first row level security policy is defined for the first database object:
dynamically generating a first filter predicate string based on the first row level security policy;
converting the first filter predicate string into a first query optimizer predicate;
injecting the first query optimizer predicate into a first query plan;
generating a first query result set during execution of the first query plan; and
applying the first query optimizer predicate to the first query result set.
